(19) United States
(12) Patent Application Publication
(10) Pub. No.: US 2016/0336590 A1
(43) Pub. Date: Nov. 17, 2016

(54) SULFUR-HYDROXYLATED GRAPHENE NANOCOMPOSITES FOR RECHARGEABLE LITHIUM-SULFUR BATTERIES AND METHODS OF MAKING THE SAME

(71) Applicant: Board of Regents, The University of Texas System, Austin, TX (US)

(72) Inventors: Arumugam Manthiram, Austin, TX (US); Chenxi Zu, Austin, TX (US)

(21) Appl. No.: 15/222,299

(22) Filed: Jul. 28, 2016

Related U.S. Application Data
(62) Division of application No. 14/202,715, filed on Mar. 10, 2014.
(60) Provisional application No. 61/776,119, filed on Mar. 11, 2013.

(51) Int. Cl. H01M 4/36; H01M 4/587; H01M 4/38; H01M 10/052; H01M 4/133

(52) U.S. Cl. CPC H01M 4/364; H01M 10/052; H01M 4/133; H01M 4/38; H01M 4/382; H01M 4/587; H01M 2004/028

(57) ABSTRACT

In one embodiment, the present disclosure provides a sulfur-hydroxylated graphene nanocomposite including at least one graphene sheet with a surface and a plurality of amorphous sulfur nanoparticles homogeneously distributed on the surface. The nanocomposite substantially lacks sulfur microparticles. In other embodiments, the disclosure provides a cathode and a battery containing the nanocomposite. In still another embodiment, the disclosure provides a method of making a sulfur-hydroxylated graphene nanocomposite by exposing a hydroxylated graphene to a sulfur-containing solution for a time sufficient to allow formation of homogeneously distributed sulfur nanoparticles on a surface of the hydroxylated graphene.

### PRIORITY CLAIM

This application is a divisional application of pending U.S. patent application Ser. No. 14/202,715 filed Mar. 10, 2014, which claims priority under 35 U.S.C. §119 to U.S. Provisional Patent Application Ser. No. 61/776,119 filed Mar. 11, 2013. The contents of which are incorporated by reference herein in their entirety.

### TECHNICAL FIELD

The current disclosure relates to cathodes for rechargeable lithium-sulfur (Li—S) batteries containing a nanocomposite of sulfur and graphene. In particular, the cathode may contain amorphous sulfur nanoparticles distributed on a graphene surface. The disclosure further relates to Li—S batteries containing such a cathode and methods of making such a cathode using hydroxylated graphene.

### BACKGROUND

### Basic Principles of Batteries and Electrochemical Cells

Batteries may be divided into two principal types, primary batteries and secondary batteries. Primary batteries may be used once and are then exhausted. Secondary batteries are also often called rechargeable batteries because after use they may be connected to an electricity supply, such as a wall socket, and recharged and used again. In secondary batteries, each charge/discharge process is called a cycle. Secondary batteries eventually reach an end of their usable life, but typically only after many charge/discharge cycles.

Secondary batteries are made up of an electrochemical cell and optionally other materials, such as a casing to protect the cell and wires or other connectors to allow the battery to interface with the outside world. An electrochemical cell includes two electrodes, the positive electrode or cathode and the negative electrode or anode, an insulator separating the electrodes so the battery does not short out, and an electrolyte that chemically connects the electrodes.

In operation the secondary battery exchanges chemical energy and electrical energy. During discharge of the battery, electrons, which have a negative charge, leave the anode and travel through outside electrical conductors, such as wires in a cell phone or computer, to the cathode. In the process of traveling through these outside electrical conductors, the electrons generate an electrical current, which provides electrical energy.

At the same time, in order to keep the electrical charge of the anode and cathode neutral, an ion having a positive charge leaves the anode and enters the electrolyte and a positive ion also leaves the electrolyte and enters the cathode. In order for this ion movement to work, typically the same type of ion leaves the anode and joins the cathode. Additionally, the electrolyte typically also contains this same type of ion. In order to recharge the battery, the same process happens in reverse. By supplying energy to the cell, electrons are induced to leave the cathode and join the anode. At the same time a positive ion, such as Li⁺, leaves the cathode and enters the electrolyte and a Li⁺ leaves the electrolyte and joins the anode to keep the overall electrode charge neutral.

In addition to containing an active material that exchanges electrons and ions, anodes and cathodes often contain other materials, such as a metal backing to which a slurry is applied and dried. The slurry often contains the active material as well as a binder to help it adhere to the backing and conductive materials, such as a carbon particles. Once the slurry dries it forms a coating on the metal backing.

Unless additional materials are specified, batteries as described herein include systems that are merely electrochemical cells as well as more complex systems.

Several important criteria for rechargeable batteries include energy density, power density, rate capability, cycle life, cost, and safety. The current lithium-ion battery technology based on insertion compound cathodes and anodes is limited in energy density. This technology also suffers from safety concerns arising from the chemical instability of oxide cathodes under conditions of overcharge and frequently requires the use of expensive transition metals. Accordingly, there is immense interest to develop alternate cathode materials for lithium-ion batteries. Sulfur has been considered as one such alternative cathode material.

### Lithium-Sulfur Batteries

Lithium-sulfur (Li—S) batteries are a particular type of rechargeable battery. Unlike most rechargeable batteries in which the ion actually moves into and out of a crystal lattice, the ion in lithium-sulfur batteries reacts with lithium in the anode and with sulfur in the cathode even in the absence of a precise crystal structure. In most Li—S batteries, the anode is lithium metal (Li or Li⁰. In operation, lithium leaves the metal as lithium ions (Li⁺) and enters the electrolyte when the battery is discharging. When the battery is recharged, lithium ions (Li⁺) leave the electrolyte and plate out on the lithium metal anode as lithium metal (Li). At the cathode, during discharge, particles of elemental sulfur (S) react with the lithium ion (Li⁺) in the electrolyte to form Li₂S. When the battery is recharged, lithium ions (Li⁺) leave the cathode, allowing the cathode to revert to elemental sulfur (S).

Sulfur is an attractive cathode candidate as compared to traditional lithium-ion battery cathodes because it offers an order of magnitude higher theoretical capacity (1675 mAh g⁻¹) than the currently employed cathodes (<200 mAh g⁻¹) and operates at a safer voltage range (1.5-2.5 V). This high theoretical capacity is due to the ability of sulfur to accept two electrons (e⁻) per atom. In addition, sulfur is inexpensive and environmentally benign.

However, the major problem with a sulfur cathode is its poor cycle life. The discharge of sulfur cathodes involves the formation of intermediate polysulfide ions, which dissolve easily in the electrolyte during the charge-discharge process and result in an irreversible loss of active material during cycling. The high-order polysulfides (Li₂Sₙ, 4≦n≦8) produced during the initial stage of the discharge process are soluble in the electrolyte and move toward the lithium metal anode, where they are reduced to lower-order polysulfides. Moreover, solubility of these high-order polysulfides in the liquid electrolytes and nucleation of the insoluble low-order sulfides (i.e., Li₂S₂ and Li₂S) result in poor capacity retention and low Coulombic efficiency. In addition, shuttling of these high-order polysulfides between the cathode and anode during charging, which involves parasitic reactions with the lithium anode and re-oxidation at the cathode, is another challenge. This process results in irreversible capacity loss and causes the build-up of a thick, irreversible Li₂S barrier on the electrodes during prolonged cycling, which is electrochemically inaccessible. Overall, the operation of Li—S cells is so dynamic that novel electrodes with optimized compositions and structure are needed to maintain the high capacity of sulfur and overcome the challenges associated with the solubility and shuttling of polysulfides. Thus, in prior Li—S batteries, polysulfides have been treated as an active intermediate product of useful electrochemical reactions. For example, some prior batteries have sought to trap polysulfide within the cathode and have achieved an actual, reversible utilization of 1.3 e⁻ per sulfur atom.

In addition to problems with polysulfide formation, sulfur is an insulator with a resistivity of 5×10⁻³° S/cm at 25° C., resulting in a poor electrochemical utilization of the active material and poor rate capacity. Although the addition of conductive carbon to the sulfur material could improve the overall electrode conductivity, the cores of the sulfur particles, which have little or no contact with conductive carbon, will still be highly resistive.

Previous attempts to address the conductivity problem have sought to increase the fraction of sulfur in contact with carbon. Several approaches have been pursued, such as forming sulfur-carbon composites with carbon black or nanostructured carbon. For example, a mesoporous carbon framework filled with amorphous sulfur with the addition of polymer has been found to exhibit a high reversible capacity of approximately 1000 mAh/g after 20 cycles. However, most traditional methods to synthesize sulfur-carbon composites include processing by a sulfur melting route, resulting in high manufacturing costs due to additional energy consumption. Also, several reports have noted that the sulfur content in the sulfur-carbon composites synthesized by the sulfur melting route is limited to a relatively low value in order to obtain acceptable electrochemical performance, leading to a lower overall capacity of the cathode.

Moreover, synthesizing homogeneous sulfur-carbon composites through conventional heat treatment is complicated. In the conventional synthesis of sulfur-carbon composites, sulfur is first heated above its melting temperature, and the liquid sulfur is then diffused to the surface or into the pores of carbon substrates to form the sulfur-carbon composite. A subsequent high-temperature heating step is then required to remove the superfluous sulfur on the surface of the composites, leading to a waste of some sulfur. Thus, the conventional synthesis by the sulfur melting route may not be scaled-up in a practical manner to obtain a uniform industry-level sulfur-carbon composite.

As another alternative, a sulfur deposition method to synthesize a core-shell carbon/sulfur material for lithium-sulfur batteries has been recently reported. However, cyclability and rate capability associated with this deposition process are not satisfactory. Furthermore, the sulfur deposition process is very sensitive and must be carefully controlled during synthesis. Otherwise, a composite with poor electrochemical performance is produced.

Previous attempts to integrate sulfur with graphene have also been made. A graphene-sulfur composite material in which sulfur particles are wrapped by polyethylene glycol (PEG) and graphene sheets showed stable capacities of 600 mAh/g over 100 cycles. Also, a one-pot reaction has been developed to obtain a graphene-enveloped sulfur composite which had high sulfur content of 87 wt % with acceptable cycling stability. In addition, a graphene oxide (GO) network anchoring sulfur has been found to effectively enhance the cycle performance of lithium-sulfur batteries. While graphene-sulfur composite cathodes demonstrate promising electrochemical performance, their synthesis is usually complicated and challenging for large-scale application. Simpler, solution-based synthesis without heat treatment produces large crystalline sulfur particles, resulting in low utilization of active materials and poor rate performance.

Accordingly, a need remains for a highly functional, readily synthesized sulfur-hydroxylated graphene cathode material.

### SUMMARY

In one embodiment, the present disclosure provides a sulfur-hydroxylated graphene nanocomposite including at least one hydroxylated graphene sheet with a surface and a plurality of amorphous sulfur nanoparticles homogeneously distributed on the surface. The nanocomposite substantially lacks sulfur microparticles.

In other embodiments, the disclosure provides a cathode and a battery containing the nanocomposite.

In still another embodiment, the disclosure provides a method of making a sulfur-hydroxylated graphene nanocomposite by exposing a hydroxylated graphene to a sulfur-containing solution for a time sufficient with ultrasonication to allow formation of homogeneously distributed sulfur nanoparticles on a surface of the hydroxylated graphene.

The following abbreviations are commonly used throughout the specification:

Li⁺—lithium ion
Li or Li⁰—elemental or metallic lithium or lithium metal
S—sulfur
Li—S—lithium-sulfur
SEM—scanning electron microscope
EDS—energy dispersive X-ray spectroscopy
XRD—X-ray diffraction
XPS—X-ray photonelectron spectroscopy
TGA—thermo gravimetric analysis
CV—cyclic voltammetry

### BRIEF DESCRIPTION OF THE DRAWINGS

A more complete understanding of the present embodiments and advantages thereof may be acquired by referring to the following description taken in conjunction with the accompanying drawings, which, when discussing sulfur-hydroxylated graphene nanocomposites, relate to embodiments of the present disclosure. The current specification contains color drawings. Copies of these drawings may be obtained from the USPTO.

FIG. 1 provides a schematic for the synthesis of sulfur-hydroxylated graphene nanocomposites.

FIG. 2A provides an SEM image of a sulfur-hydroxylated graphene nanocomposite.

FIG. 2B provides a magnified SEM image of a sulfur-hydroxylated graphene nanocomposite.

FIG. 2C provides EDS sulfur mapping of the region shown in FIG. 2B.

FIG. 2D provides EDS carbon mapping of the region shown in FIG. 2B.

FIG. 3A provides a high-resolution C1s spectrum for hydroxylated graphene.

FIG. 3B provides a high-resolution C1s spectrum for a sulfur-hydroxylated graphene nanocomposite.

FIG. 3C provides a high-resolution S2p XPS spectrum for a sulfur-hydroxylated graphene nanocomposite. The spectrum has been fitted and the sum of fitting curves (dashed line) is shown in addition to the raw data (solid line).

FIG. 4 provides FTIR spectra of pristine graphene nanosheets (GNS), hydroxylated graphene nanosheets (GNSOH), and a sulfur-hydroxylated graphene nanocomposite (GNSOH-S).

FIG. 5 provides XRD patterns for pure sulfur (S), a pristine graphene nanosheet (GNS), or a sulfur-hydroxylated graphene nanocomposite (GNSOH-S).

FIG. 6A provides a cyclic voltammogram of a Li—S battery formed with a sulfur-hydroxylated graphene nanocomposite cathode at a scan rate of 0.2 mV/s between 2.8 V and 1.8 V.

FIG. 6B provides discharge/charge voltage profiles of a Li—S battery formed with a sulfur-hydroxylated graphene nanocomposite cathode at C/2, where 1 C is 1675 mA/g.

FIG. 6C provides Nyquist plots of the charged state of a Li—S battery with a sulfur-hydroxylated graphene nanocomposite cathode when cycled at 1C.

FIG. 6D provides the cycle performance of a Li—S battery with a sulfur-hydroxylated graphene nanocomposite cathode at C rates of C/2, 1C and 2C.

FIG. 7A provides SEM images of a sulfur-graphene microcomposite.

FIG. 7B provides an XRD pattern of a sulfur-graphene microcomposite.

FIG. 8 provides a comparison of cycle performance of Li—S batteries with a sulfur-hydroxylated graphene nanocomposite (GNSOH-S) or with a sulfur-graphene microcomposite (GNS-S).

FIG. 9A provides an SEM image of a cycled sulfur-hydroxylated graphene nanocomposite cathode.

FIG. 9B provides an EDS sulfur mapping of the region shown in FIG. 9A.

FIG. 9C provides an EDS carbon mapping of the region shown in FIG. 9A.

FIG. 10 provides the UV-visible absorption spectra of solutions obtained by soaking cycled discharged-state cathodes containing a sulfur-hydroxylated graphene nanocomposite in a mixture of DOL/DME (1:1 vol).

FIG. 11 provides cycle performance data for sulfur-hydroxylated graphene nanocomposites with different sulfur loadings.

FIG. 12 provides TGA data for sulfur-hydroxylated graphene nanocomposites with different sulfur loadings.

### DETAILED DESCRIPTION

The current disclosure relates to cathodes for rechargeable lithium-sulfur (Li—S) batteries containing a nanocomposite of sulfur and hydroxylated graphene. In particular, the cathode may contain amorphous sulfur nanoparticles distributed on a graphene surface. The disclosure further relates to Li—S batteries containing such a cathode and methods of making such a cathode using hydroxylated graphene.

“Graphene” as used in the present disclosure, may include any sheet-like material that is substantially one atom-thick and substantially formed from double bonded carbon atoms. Graphene may also be characterized by the honeycomb appearance of the carbon atoms. Graphene may include graphene oxide. Hydroxylated graphene may include graphene oxide with mainly hydroxyl groups and few or no carboxyl groups or epoxy bridges. The study of graphene remains a highly dynamic field. Accordingly, graphene, as used herein, unless otherwise specifically indicated, includes graphene variations presently in existence as well as any developed in the future otherwise compatible with this disclosure.

### Sulfur-Hydroxylated Graphene Nanocomposites, Cathodes, and Batteries

Sulfur-hydroxylated graphene nanocomposites of the present disclosure may contain amorphous sulfur nanoparticles distributed on a hydroxylated graphene surface. These nanoparticles may be substantially made of elemental sulfur. The nanoparticles may be distributed uniformly on the hydroxylated graphene surface.

In one embodiment, the nanocomposite may contain at least 30 wt % sulfur, at least 50 wt % sulfur, at least 80 wt % sulfur, or at least 90 wt % sulfur. It may also include ranges of sulfur by wt % between any of these endpoints.

In one embodiment, sulfur microparticles may be substantially absent from the sulfur-hydroxylated graphene nanocomposite. In particular, less than 5% less than 2%, or less than 1% of the particles may be microparticles.

The hydroxylated graphene may be in the form of a sheet, although when cathodes are formed, layers of graphene sheets may be used, so long as they remain sufficiently spaced to allow lithium ion (Li⁺ movement). Cathodes may also contain other materials to improve conductivity or mechanical stability, such as metal foil or other conductive foil on which the sulfur-hydroxylated graphene nanocomposite is deposited.

The close electrochemical contact between sulfur nanoparticles and the hydroxylated graphene, which is highly conductive, allows the formation of cathodes that, when placed in a Li—S battery exhibit reversible discharge capacities of at least 1,022 mAh/g (based on mass of S) after 100 cycles at C/2, at least 955 mAh/g (based on mass of S) after 100 cycles at C1, or at least 647 mAh/g (based on mass of S) after 100 cycles at 2C. Capacity retention over 100 cycles may be at least 80% or at least 90%. These batteries may also exhibit a Coulombic efficiency of at least 95%.

Additionally, the amorphous state of sulfur particles in the nanocomposite has close contact with the hydroxylated graphene substrate, preventing the dissolution of polysulfides during use of the cathode. Sulfur nanoparticles provide short pathways for ion and electron transport. The unique sponge-like morphology of the sulfur-hydroxylated graphene nanocomposite allows complete electrolyte penetration and absorbs the strain from cycling-induced volume changes during battery use.

Unless otherwise indicated by the context, the term “battery” as uses herein includes both simple electrochemical cells and more complex multi-cell arrangements.

According to one embodiment, the disclosure provides a battery with a cathode containing a sulfur-hydroxylated graphene nanocomposite as described herein, an anode suitable for use with the cathode and in which lithium ions (Li⁺) can intercalate or be deposited, such as lithium metal (Li or Li⁰, lithiated silicon, lithiated tin, Li₄Ti₅O₁₂, lithium-containing oxides or sulfides, or lithium-containing organics, such as Li₂C₆O₆, Li₂C₈H₄O₄, Li₂C₆H₄O₄, or other lithium-containing materials, and an electrolyte suitable for use with the cathode and anode, such as lithium trifluoromethanesulfonate (LiCF₃SO₃, 1 M) or other lithium salts, such as lithium bis(trifluoromethanesulfonyl)imide (LITFSI, 1 M)) and lithium nitrate (LiNO₃, 0.1 M), dissolved in 1,3-dioxalane (DOL) and 1,2-dimethoxyethane (DME) (1:1, vol, or other solvents, such as tetra(ethylene glycol)dimethyl ether). The battery may also contain a separator to electrically insulate the cathode and anode. In some batteries, the separator may also be the electrolyte.

Batteries of the present disclosure may also contain contacts, a casing, or wiring. In the case of more sophisticated batteries, they may contain more complex components, such as safety devices to prevent hazards if the battery overheats, ruptures, or short circuits. Particularly complex batteries may also contain electronics, storage media, processors, software encoded on computer readable media, and other complex regulatory components.

Batteries may be in traditional forms, such as coin cells or jelly rolls, or in more complex forms such as prismatic cells. Batteries may contain more than one electrochemical cell and may contain components to connect or regulate these multiple electrochemical cells.

Batteries of the present disclosure may be used in a variety of applications. They may be in the form of standard battery size formats usable by a consumer interchangeably in a variety of devices. They may be in power packs, for instance for tools and appliances. They may be usable in consumer electronics including cameras, cell phones, gaming devices, or laptop computers. They may also be usable in much larger devices, such as electric automobiles, motorcycles, buses, delivery trucks, trains, or boats. Furthermore, batteries according to the present disclosure may have industrial uses, such as energy storage in connection with energy production, for instance in a smart grid, or in energy storage for factories or health care facilities, for example in the place of generators.

### Methods of Forming Sulfur-Hydroxylated Graphene Nanocomposites

Sulfur-graphene nanocomposites of the present disclosure may be formed using an in situ sulfur deposition method of hydroxylated graphene at room temperature. In particular, the sulfur-hydroxylated graphene nanocomposites may be formed through hydroxyl group-induced heterogeneous nucleation of bonded sulfur atoms through extraction from a sulfur salt solution

Hydroxylated graphene nanosheets may be prepared by any suitable method, including, but not limited to, ultrasonication-hydrothermal methods, ball-milling methods or Chemical Vapor Deposition methods. Hydroxylated graphene may be in the form of sheets, such as graphene nanosheets.

The sulfur salt solution may be any salt solution from which sulfur may be extracted through hydroxyl group nucleation in an acidic environment.

Sulfur nanoparticle deposition may be substantially complete in less than one hour.

Due to strong interactions between the hydroxyl groups on the graphene and sulfur in the sulfur salt in solution and any intermediate polysulfides, the sulfur nanoparticles formed on the graphene surface are amorphous.

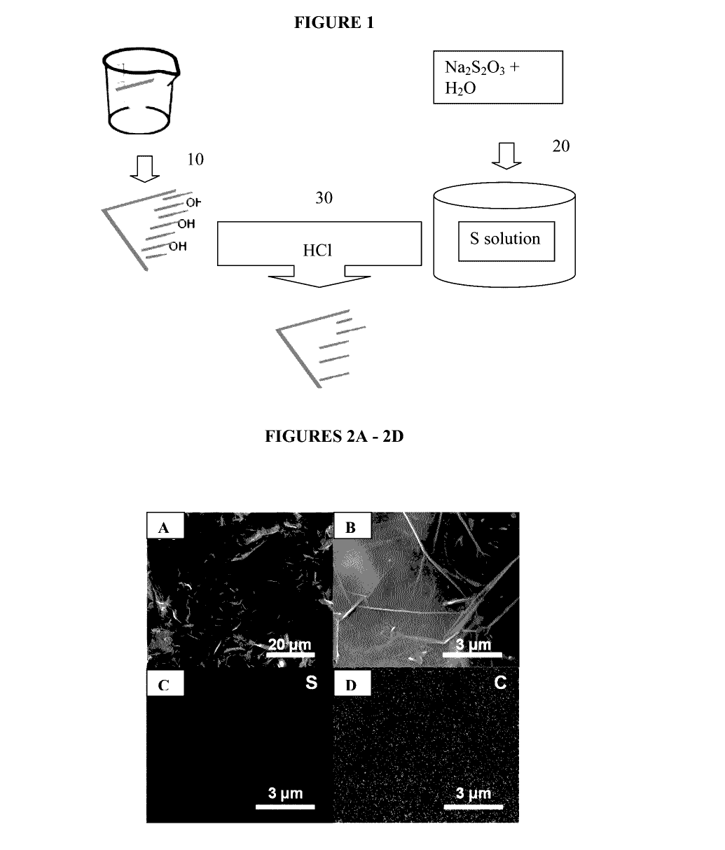

In a particular embodiment, shown in FIG. 1, in step 10 hydroxylated graphene is prepared by a sonication-hydrothermal method, which results in the formation of hydroxyl groups on graphene sheets. A sulfur-containing solution may be prepared as shown in step 20 by dissolving of sodium thiosulfate. In step 30, the sulfur-containing solution may be brought into contact with the hydroxylated graphene under ultrasonication and with addition of hydrochloric acid, resulting in the formation of a sulfur-hydroxylated graphene nanocomposite.

### EXAMPLES

The following examples are provided to further illustrate specific embodiments of the disclosure. They are not intended to disclose or describe each and every aspect of the disclosure in complete detail and should not be so interpreted.

### Example 1

### Synthesis of a Sulfur-Hydroxylated Graphene Nanocomposite

Pristine graphene nanosheets (SkySpring Nanomaterials Inc., USA) were synthesized through a mechanical exfoliation method. Sodium hydroxide (NaOH, Fisher Scientific, AR), sodium thiosulfate (Na₂S₂O₃, Fisher Scientific, AR), hydrochloride acid (HCl, 37%, Fisher Scientific, AR), lithium nitrate (LiNO₃, Fisher Scientific, AR), poly(vinylidene fluoride) (PVDF 1120, Kureha), carbon black (SuperP, Alfa Aesar), N-methyl-2-pyrrolidinone (NMP, anhydrous, 99.5%, Sigma-Aldrich), lithium trifluoromethanesulfonate (LiCF₃SO₃, 98%, Acros Organics), 1,3-dioxolane (DOL, Acros Organics), and 1,2-dimethoxyethane (DME, Acros Organics) were used as received.

Pristine graphene nanosheets (1.0 g) were dispersed in aqueous NaOH (3.2 g) solution (40 mL, 2 M) with the aid of ultrasonication (Sonics & Materials, Inc) for 30 minutes at room temperature as described in D. Yang, G. Guo, J. Hu, C. Wang, D. Jiang, J. Mater. Chem. 18:350 (2008) portions relating to generating hydroxylated carbon nanotubes, incorporated in material part by reference herein. Next, the mixture was transferred into a stainless steel reaction autoclave (50 mL) with a polytetrafluoroethylene liner, heated to 180° C. for 2 hours, and cooled to room temperature. The reaction mixture was washed with methanol and de-ionized (DI) water until the pH reached 7.0 and dried in a vacuum oven at 50° C.

A general description of the method used in this example is provided in FIG. 1. First, Na₂S₂O₃ (0.02 mol) was dissolved in deionized water (500 mL), followed by magnetic stirring for 5 minutes. Next, the as-synthesized hydroxylated graphene nanosheets (0.06 g, 0.045 g, or 0.03 g) were suspended in the above solution to produce composites with different sulfur loadings. The mixture was ultrasonicated for 30 minutes. Concentrated hydrochloric acid (0.5 mL) was then added into the solution drop-wise to precipitate sulfur homogeneously on the hydroxylated graphene nanosheets. The reaction proceeded for 45 minutes before the product was filtered, washed with deionized water, and dried under vacuum at 50° C.

### Example 2

### Structural and Chemical Analysis of a Sulfur-Hydroxylated Graphene Nanocomposite

Sulfur-graphene nanocomposites formed in Example 1 were subjected to structural and chemical analysis.

The morphology of the sulfur-hydroxylated graphene nanocomposite was examined with a FEI Quanta 650 scanning electron microscope (SEM). The sulfur-graphene nanocomposite possesses a sponge-like morphology with fully exfoliated graphene nanosheets as shown in FIG. 2A. FIG. 2B shows the morphology of a single graphene nanosheet, in which no bulk sulfur particles can be seen.

Elemental mapping and the composition of the nanocomposite was analyzed by energy dispersive X-ray spectroscopy (EDS, FEI). Results are shown in FIGS. 2C and 2D. Homogenous distribution of sulfur and carbon in a single graphene nanosheet was seen, indicating that sulfur forms highly-dispersed nanoparticles.

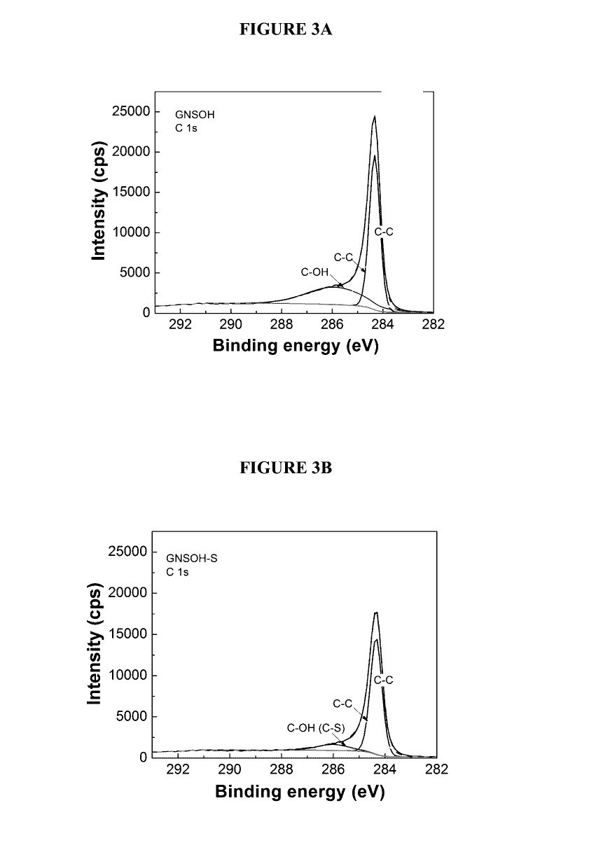

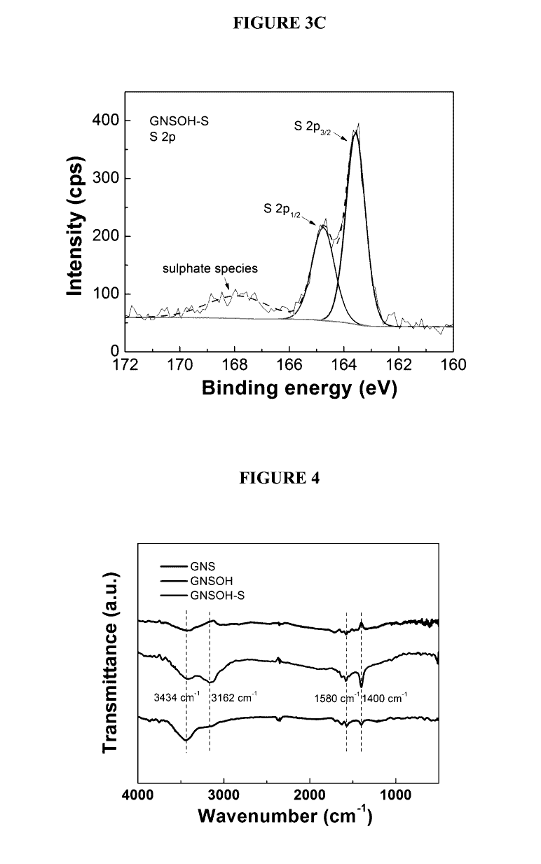

To examine the surface characteristics of the sulfur-hydroxylated graphene nanocomposite, X-ray photoelectron spectroscopy (XPS, Kratos Analytical Company) analysis of the hydroxylated graphene without sulfur and sulfur-hydroxylated graphene nanocomposite was performed. Results are shown in FIGS. 3A, 3B and 3C. The C1s spectrum of the hydroxylated graphene alone showed an overlap of three peaks at 284.3 eV, 284.6 eV, and 286.0 eV, which can be ascribed to the graphitic carbon, sp² carbon (C═C), and hydroxylated carbon (C—OH), respectively. In contrast, the sulfur-hydroxylated graphene nanocomposite had a C1s spectrum with reduced intensity, due to the sulfur coverage on the graphene surface. In particular, the peak intensity of the hydroxylated carbon dropped significantly, implying possible partial cleavage of the C—OH bond during the sulfur precipitation reaction and formation of a carbon bond with a less electronegative atom, e.g., a C—S bond with a binding energy of 285.7 eV. In addition, the S2p spectrum in FIG. 3C (sulfur-hydroxylated graphene nanocomposite) had a S 2p3/2 and 2p1/2 doublet with an energy separation of 1.2 eV and intensity ratio of about 2:1. The fitted S 2p3/2 peak had a binding energy of 163.6 eV, which was slightly lower than that of elemental sulfur, indicating possible presence of C—S species. The small shoulder at 167.8 eV may be ascribed to sulphate species from the remaining precursor or to oxidized sulfur in the air.

To further confirm the surface characteristics of the graphene without sulfur and the sulfur-hydroxylated graphene nanocomposite, Fourier transform-infrared spectroscopy (FTIR, Perkin-Elmer Spectrum RX-1) was also performed, the results of which are presented in FIG. 4. The pristine graphene showed a weak signal of stretching corresponding to hydroxyl groups at 3,434 cm⁻¹. In contrast, the peak intensity at 3,434 cm⁻¹ increased significantly in the spectrum of the sulfur-hydroxylated graphene nanocomposite. In addition, the emerging peaks at around 3,162 cm⁻¹ and 1,400 cm⁻¹, which correspond, respectively, to the stretching and bending of hydroxyl groups on phenols, further confirmed the enriching hydroxyl groups in the sulfur-hydroxylated graphene nanocomposite. Moreover, the peak at 1,580 cm⁻¹ that became more intense may be attributed to the stretching of C═C bonds. As expected, the peaks of hydroxyl groups at 3,162 cm⁻¹ and 1,400 cm⁻¹ in the pristine graphene almost disappeared in the sulfur-hydroxylated graphene nanocomposite, implying that the C—OH bonds on the graphene nanosheets were partially converted to C—S bonds.

The XPS and FTIR results confirm that the hydroxyl groups were introduced onto the graphene nanosheets, and the hydroxyl groups were involved in the sulfur deposition reaction, resulting in some sulfur attached to the graphene with uniform morphology.

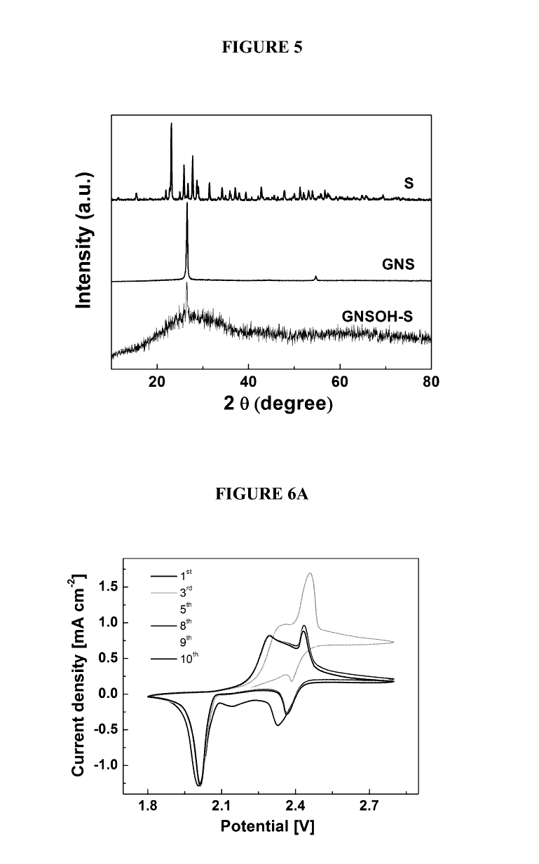

Crystal structural characterization was carried out with a Philips X-ray Diffractometer (XRD) with CuKα radiation between 10 and 80° at a scan rate of 0.04° s⁻¹. XRD was conducted on pure sulfur powder, pristine graphene nanosheets, and the sulfur-hydroxylated graphene nanocomposite, as shown in FIG. 5. The pattern of the sulfur-hydroxylated graphene nanocomposite revealed the graphene peak at 23° with reduced intensity, but no crystalline sulfur peaks due to the amorphous state of sulfur or due to its attachment to graphene. This most likely indicates that (i) the hydroxyl groups on the sulfur-hydroxylated graphene nanocomposite interact with the sulfur precursor via a hydrogen-bonding interaction, creating active sites for the complete heterogeneous nucleation and (ii) the hydroxyl groups prevent the sulfur from growing into bulk crystalline particles.

### Example 3

### Electrochemical Analysis of a Sulfur-Hydroxylated Graphene Nanocomposite

Sulfur-graphene nanocomposites formed in Example 1 were subjected to electrochemical analysis in CR2032 coin cells. The cathode contained 80 wt % of sulfur-hydroxylated graphene nanocomposite, a high loading of active material, and was prepared by mixing sulfur-hydroxylated graphene nanocomposite (80 wt %), SuperP (10 wt %), and PVDF binder (10 wt %) in an N-methylpyrrolidone (NMP) solution. The well-mixed slurry was then cast onto an aluminium foil and the resulting film was dried in an oven at 50° C. CR2032 coin cells consisting of a metallic lithium anode, a Celgard separator, and the sulfur-hydroxylated graphene nanocomposite cathode were assembled in an argon-filled glovebox. The electrolyte used was LiCF₃SO₃(1 M) and LiNO₃(0.1 M) dissolved in 1,3-dioxalane (DOL) and 1,2-dimethoxyethane(DME) (1:1, vol). Galvanostatic cycling was conducted with an Arbin battery cycler at 2.8-1.8 V (vs. Li/Li⁺) at room temperature.

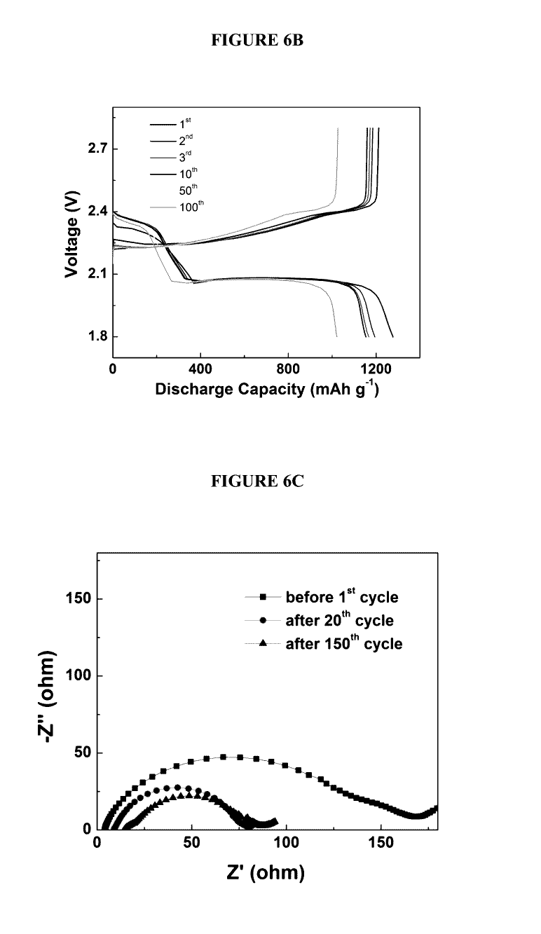

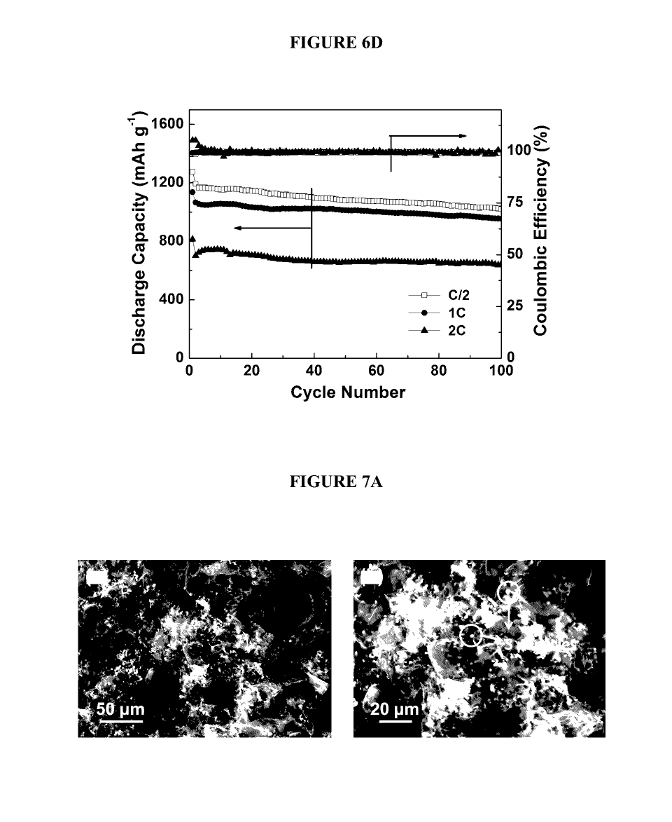

FIG. 6A shows the cyclic voltammetry (CV) profiles of the half cell within the voltage window of 2.8-1.8 Vat a scan rate of 0.2 mV/s. The CV data were obtained with a VoltaLab PGZ 402 Potentiostat. The reduction peak at 2.33 V shifted to higher potentials and the oxidation peak at 2.46 V shifted to lower potentials upon cycling, indicating improved reversibility of the cell. After 7 cycles, the CV profiles showed a complete overlapping of the cathodic and anodic peaks, suggesting an effective retention of capacity and prevention of the shuttle mechanism. The reduction peaks stabilized at 2.35 V and 2.03 V, which is in agreement with the processes of reducing high-order polysulfides to Li₂S₄ and reducing Li₂S₄ to Li₂S₂ or Li₂S. The oxidation peaks stabilized at 2.30 V and 2.43 V, suggesting a two-plateau oxidation process. In the CV profiles, a positive deviation of current densities from zero in the high voltage region during the cathodic sweep was observed in the first few cycles, implying a retarded transition between low-order and high-order polysulfides. It is likely that polysulfides formed in the redox reaction are not free, but instead are bonded to the graphene via the C—S bonds as indicated by the XPS and FTIR results. The bonded sulfur was slowly converted to free but highly dispersed reactive materials upon cycling, which is consistent with the later stable CV profiles (e.g., 8^{th}, 9^{th}, and 10^{th} cycles). This result suggests that the hydroxyl groups introduced to the graphene alter the way sulfur is formed and the redox reaction sulfur undergoes. The CV data also indicates that hydroxyl groups on graphene may be consumed during cycling.

The reduction and oxidation plateaus remained relatively constant over 100 cycles as shown in the selected discharge/charge curves in FIG. 6B, indicating that no obvious polarization occurs. The reduced internal impedance also suggests a more reversible cell upon cycling, as shown in the Nyquist plots of FIG. 6C.

To examine the electrochemical cycle performance, cells with the sulfur-hydroxylated graphene nanocomposite cathodes were cycled at rates of C/2, 1C, and 2C (1C=1,675 mA/g based on mass of S), as shown in FIG. 6D. High initial discharge capacities of 1,277 mAh/g based oh mass of S, 1,136 mAh/g based on mass of S, and 815 mAh/g based on mass of Swere obtained, respectively, at C/2, 1C, and 2C rates. The high initial discharge capacities attest to high utilization of the active material in the sulfur-hydroxylated graphene cathode, which is attributed to the unique sponge-like morphology of the nanocomposite, allowing complete electrolyte penetration. In addition, the highly dispersed sulfur nanoparticles on the graphene surface provide sufficient contact between sulfur and the conductive matrix. Even after 100 cycles, reversible capacities of 1,021 mAh/g, 955 mAh/g, and 647 mAh/g, all based on mass of S, were retained, respectively, at C/2, 1C, and 2C with a capacity retention of as high as 84% and Coulombic efficiency of nearly 100% for most cycles.

### Example 4

### Comparison with Sulfur-Hydroxylated Graphene Nanocomposite and Sulfur-Graphene Microcomposite

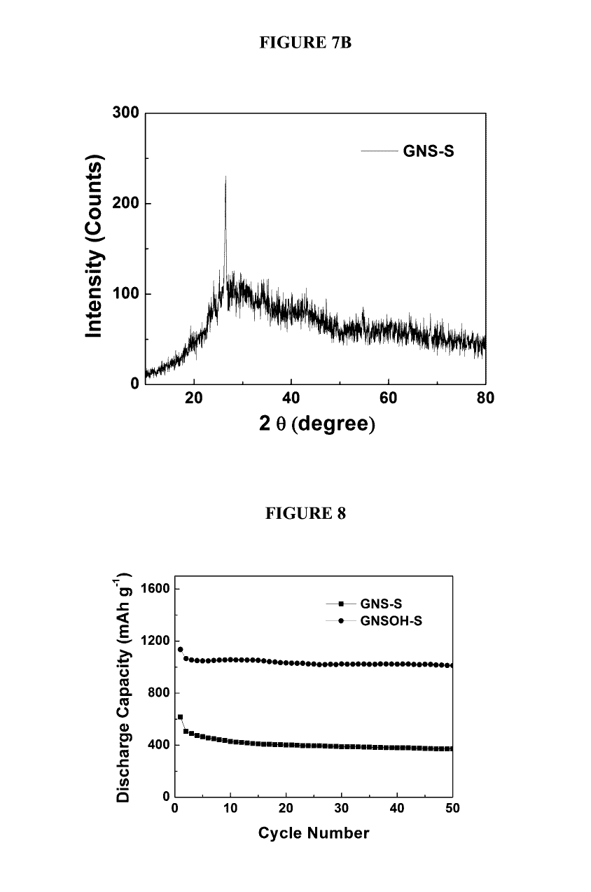

Pristine graphene nanosheets without hydroxylation were also coupled with sulfur following the same chemical deposition method as described in Example 1 to form sulfur-graphene microcomposites. Comparative sulfur-hydroxylated graphene nanocomposites were also formed. Sulfur content in both materials was 50 wt %. In contrast to the sulfur-hydroxylated graphene nanocomposite, the materials formed without hydroxyled graphene contained micro-sized sulfur particles, which may be seen in the SEM images (FIG. 7A). Although pristine graphene nanosheets have trace amounts of hydroxyl groups as seen in FIG. 4, which likely come from the production process, and although these groups can induce heterogeneous nucleation of amorphous sulfur nanoparticles, as seen in FIG. 7B, a huge difference is nevertheless observed in electrochemical performance when graphene is not hydroxylated and sulfur microparticles are formed and when graphene is hydroxylated and sulfur nanoparticles are formed, as seen in FIG. 8.

The large capacity difference between the two composites remained relatively uniform during cycling, indicating little change in the utilization of active materials during cycling.

### Example 5

### Post-Cycling Chemical and Structural Analysis of a Sulfur-Hydroxylated Graphene Nanocomposite

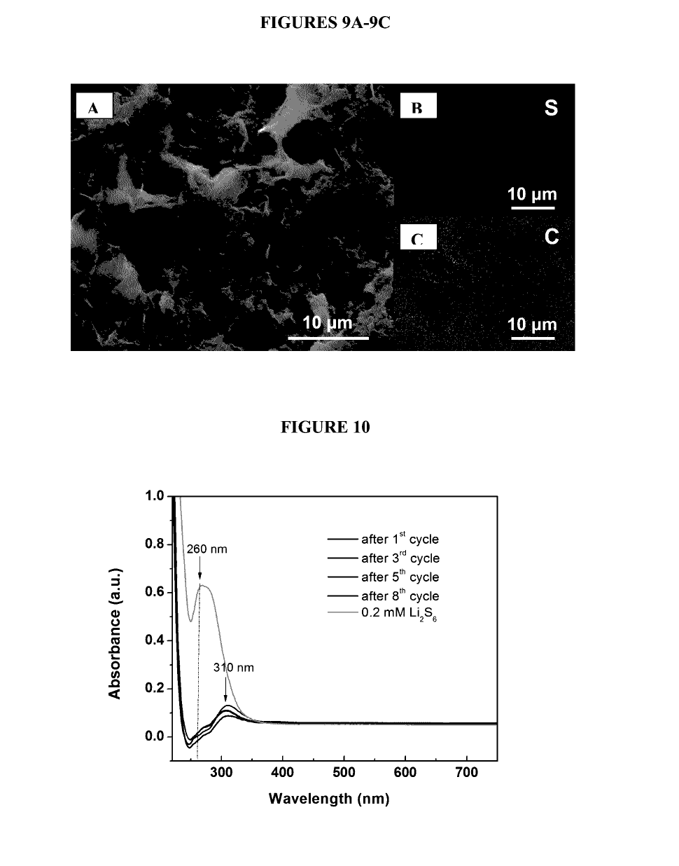

The sulfur-hydroxylated graphene nanocomposite may contain residual hydroxyl groups, which may attract polysulfides during cycling through hydrophilic-hydrophilic interactions as shown in FIG. 9, which presents the SEM and EDS images of a sulfur-hydroxylated graphene cathode after 100 cycles in a battery as described in Example 3. This contributes to capacity retention and morphology conservation.

UV-visible absorption spectroscopy was used to characterize the polysulfide species and their content in the electrolyte after the cells as described in Example 3 completed a certain number of cycles. Typically, the cells containing the sulfur-hydroxylated graphene nanocomposite cathode were cycled at C/2 rate for 1, 3, 5, or 8 cycles and rested for 3 days; each cycled cathode (discharged state) was then soaked in 8 mL of a mixed solution of DOL/DME (1:1, vol) for 5 minutes. The resulting solution was then characterized by a Cary 5000 Spectrophotometer (Varian). A baseline correction was used to deduct the influence of the mixture of DOL/DME (1:1, vol).

UV-visible absorption spectroscopy results are presented in FIG. 10 and also show low sulfur mobility in the sulfur-hydroxylated graphene nanocomposite cathode. The polysulfide content in the electrolyte was relatively the same after the 1^{st}, 3^{rd}, 5^{th}, and 8^{th} cycles as revealed by the similar bands and band peak intensities of the polysulfide in the electrolyte. For a comparison, a standard polysulfide solution of 0.2 mM Li₂S₆ was prepared, and its UV-visible spectrum is also shown in FIG. 10. The 260 nm band is attributed to the S₆²⁻ or S₃²⁻ species, and the 310 nm band is attributed to the S₆²⁻ or S4²⁻ species.

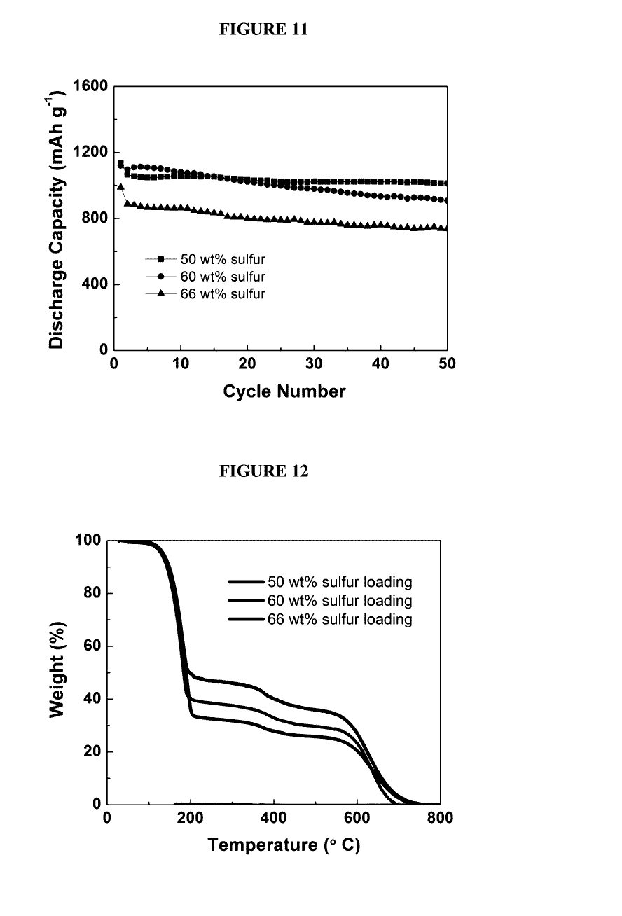

The cycle performance of the Li—S batteries with the sulfur-hydroxylated graphene nanocomposites possessing different sulfur contents were also compared in FIG. 11. Superior high rate performance evidences the efficient use of active material and the effective prevention of polysulfide dissolution from the sulfur-hydroxylated graphene nanocomposite cathode. Samples were also analyzed using thermo gravimetric analysis (TGA), which was conducted with a TGA 7 (Perkin-Elmer) thermogravimetric analyzer in air at a scan rate of 5° C./minute from room temperature to 800° C. (FIG. 12).

Although only exemplary embodiments of the disclosure are specifically described above, it will be appreciated that modifications and variations of these examples are possible without departing from the spirit and intended scope of the disclosure. For instance, numeric values expressed herein will be understood to include minor variations and thus embodiments “about” or “approximately” the expressed numeric value unless context, such as reporting as experimental data, makes clear that the number is intended to be a precise amount.

1. A sulfur-hydroxylated graphene nanocomposite comprising:
at least one hydroxylated graphene sheet with a surface; and
a plurality of amorphous sulfur nanoparticles homogeneously distributed on the surface,
wherein the nanocomposite substantially lacks sulfur microparticles.

2. The nanocomposite of claim 1, wherein the nanocomposite comprises at least 30 wt % sulfur.

3. The nanocomposite of claim 1, wherein the sulfur nanoparticles are bound to the graphene via hydroxyl groups.

4. A cathode comprising a sulfur-hydroxylated graphene nanocomposite comprising:
at least one hydroxylated graphene sheet with a surface; and
a plurality of amorphous sulfur nanoparticles homogeneously distributed on the surface,
wherein the nanocomposite substantially lacks sulfur microparticles.

5. The cathode of claim 4, wherein the nanocomposite comprises at least 30 wt % sulfur.

6. The cathode of claim 4, wherein the sulfur nanoparticles are bound to the graphene via hydroxyl groups.

7. A rechargeable lithium-sulfur battery comprising:
a cathode comprising a sulfur-hydroxylated graphene nanocomposite comprising:
at least one hydroxylated graphene sheet with a surface; and
a plurality of amorphous sulfur nanoparticles homogeneously distributed on the surface,
wherein the nanocomposite substantially lacks sulfur microparticles;
an anode; and
an electrolyte.

8. The battery of claim 7, wherein the nanocomposite comprises at least 30 wt % sulfur.

9. The battery of claim 7, wherein the sulfur nanoparticles are bound to the graphene via hydroxyl groups.

10. The battery of claim 7, wherein the anode comprises lithium metal, lithiated silicon, lithiated tin, Li₄Ti₅O₁₂, lithium-containing oxides or sulfides, or lithium-containing organics, such as Li₂C₆O₆, Li₂C₈H₄O₄, Li₂C₆H₄O₄,

11. The battery of claim 7, wherein the electrolyte comprises lithium trifluoromethanesulfonate, lithium bis(trifluoromethanesulfonyl)imide, lithium nitrate, other lithium salts, or combinations thereof dissolved in 1,3-dioxalane, 1,2-dimethoxyethane, tetra(ethylene glycol)dimethyl ether, other solvents, or any combinations thereof.

12. The battery of claim 7, wherein the battery exhibits a reversible discharge capacity of at least 1,022 mAh/g based on mass of S after 100 cycles at C/2, at least 955 mAh/g based on mass of S after 100 cycles at C1, or at least 647 mAh/g based on mass of S after 100 cycles at 2C.

13. The battery of claim 7, wherein the battery retains at least 80% capacity over 100 cycles.

14. The battery of claim 7, wherein the battery has a Coulombic efficiency of at least 95%.
